(19) United States
(12) Patent Application Publication
(10) Pub. No.: US 2025/0100106 A1
(43) Pub. Date: Mar. 27, 2025

(54) OPTICAL FIBER POLISHING ARM ASSEMBLY

(71) Applicant: Domaille Engineering, LLC, Rochester, MN (US)

(72) Inventors: Gregory A. Schumacher, Plainview, MN (US); John P. Hagen, Plainview, MN (US); Dennis J. Anderson, Zumbro Falls, MN (US); Jill B. Christie, St. Charles, MN (US); Timothy E. Kanne, Rochester, MN (US); Paul S. Fishbaugher, Rochester, MN (US)

(73) Assignee: Domaille Engineering, LLC, Rochester, MN (US)

(21) Appl. No.: 18/728,185

(22) PCT Filed: Dec. 7, 2022
(86) PCT No.: PCT/US2022/052133

§ 371 Date: Jul. 11, 2024

Related U.S. Application Data
(60) Provisional application No. 63/311,363, filed on Feb. 17, 2022.

(51) Int. Cl. B24B 41/06; B24B 19/22

(52) U.S. Cl. CPC B24B 41/06; B24B 19/226

(57) ABSTRACT

An optical fiber polishing arm assembly comprises a base, at least one side support, an overarm, and a lock shaft. The at least one side support is operatively connected to the base and has a first radial edge with at least one notch. The overarm is pivotally operatively connected to the base and includes a lock bore selectively aligned with the at least one notch. The lock shaft extends at least partially through the lock bore and is configured and arranged to selectively engage the at least one notch.

### CROSS-REFERENCE TO RELATED APPLICATIONS

This application claims the benefit of U.S. Provisional Patent Application Ser. No. 63/311,363, filed Feb. 17, 2022, which is incorporated by reference in its entirety herein.

### BACKGROUND

A fiber optic cable generally includes a protective or supporting material through which optical fibers extend. The cables or ribbons typically have connectors located on each end to connect them to other fiber optic cables or ribbons or to peripheral devices, and the connectors are high precision devices that position the optical fibers for optimal connection.

In order to pass light signals through optical fibers, the end face of the connector (from which a ferrule and optical fibers extend) must abut an adjacent connector in a specific manner. The high tolerances required of the parts to make these connections lead to precise shaping of the ends of the optical fibers via cleaving, cutting, and/or polishing. Apex offset, radius of curvature, fiber protrusion/recession, and angularity are all geometric parameters of the optical fiber end face that play into the quality of the signal passing through it. Final test measurements for back reflection and insertion loss are typically used as the final checks to determine the quality of the geometry (as well as the alignment, cleanliness, and surface finish of the finished cable). As such, the end face is usually cleaved, cut and/or polished to exacting standards so as to produce a finished product with minimal back reflection and loss. For example, it is often necessary to cleave, cut, and/or polish the end face of the connector to a precise length, i.e., so the end face projects a predetermined amount from a reference point such as a shoulder on the fiber optic connector within a predetermined tolerance. Fiber optic cables having multiple optical fibers can also be cleaved, cut, and/or polished to produce a particular performance specification.

Optical fiber polishers typically include a rotating platen and a polishing mechanism, such as a polishing arm mechanism (arm or overarm assembly), that positions and supports the connectors during the polishing process. Typically, the end face is lowered onto a film resting on the platen, and depending upon the film, the speed of the platen, the pressure applied, and its duration, acquires a product suitable for a particular application. Optical fiber polishers generally include a fixture coupled to the arm mechanism that is capable of holding and gripping one or more fiber optic connectors and advancing them under controlled conditions of speed and force to engage a plurality of fiber optic ends into engagement with a polishing member such as a rotatable platen having an abrasive surface (e.g., a platen with a pad having a film with an abrasive surface positioned thereon).

The manufacturing process for building a finished fiber optic connector typically involves polishing it at various speeds and pressures using various polishing films. Typically, the process will start with a more aggressive film of higher abrasive particle size at lower speeds and pressures and work toward smaller particle size films at faster speeds and higher pressures.

In some optical fiber polishers, the arm assembly can wear and require replacement of some of its parts, for example, the overarm lock assembly. The locking pins are typically replaced once before the entire locking mechanism should be replaced.

For the reasons stated above and for other reasons stated below, which will become apparent to those skilled in the art upon reading and understanding the present specification, there is a need in the art for an optical fiber polishing arm assembly that is more secure and durable.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an optical fiber polishing arm assembly comprises a base, a first side support, an overarm, and a lock shaft. The first side support is operatively connected to the base and has a first radial edge with at least a first notch. The overarm is pivotally operatively connected to the base and includes a lock bore selectively aligned with the first notch. The lock shaft extends at least partially through the lock bore and is configured and arranged to selectively engage the first notch.

In one embodiment, an optical fiber polishing arm assembly comprises a base, first and second side supports, an overarm, and a lock shaft. The first side support and the second side support are operatively connected to the base and form a channel therebetween. The first side support has a first radial edge with at least a first notch, and the second side support has a second radial edge with at least a second notch. The first and second notches are aligned. The overarm is pivotally operatively connected to the base within the channel, and the overarm includes a lock bore selectively aligned with the first and second notches. The lock shaft extends through the lock bore and is configured and arranged to selectively engage the first and second notches.

In one embodiment method, an optical fiber polishing arm assembly is repositioned by pressing a button thereby actuating a pneumatic cylinder to move a lock shaft from a first engaging position into a releasing position by moving the lock shaft out of a first pair of notches. An overarm is positioned between the first pair of notches and the lock shaft extends through a lock bore in the overarm. There is an angular difference between the first pair of notches and the lock bore. The overarm is positioned in a desired position and the button is released thereby moving the lock shaft into a second engaging position by moving the shaft into a second pair of notches. As the lock shaft moves within the lock bore, downward pressure increases on the overarm due to the angular difference.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a perspective view of an embodiment optical fiber polisher constructed in accordance with the principles of the present invention with an optional cable management attachment and an optional drip tray/splash guard.

FIG. 2 is a partially exploded perspective view of the optical fiber polisher shown in FIG. 1 without the optional cable management attachment and the optional drip tray/splash guard.

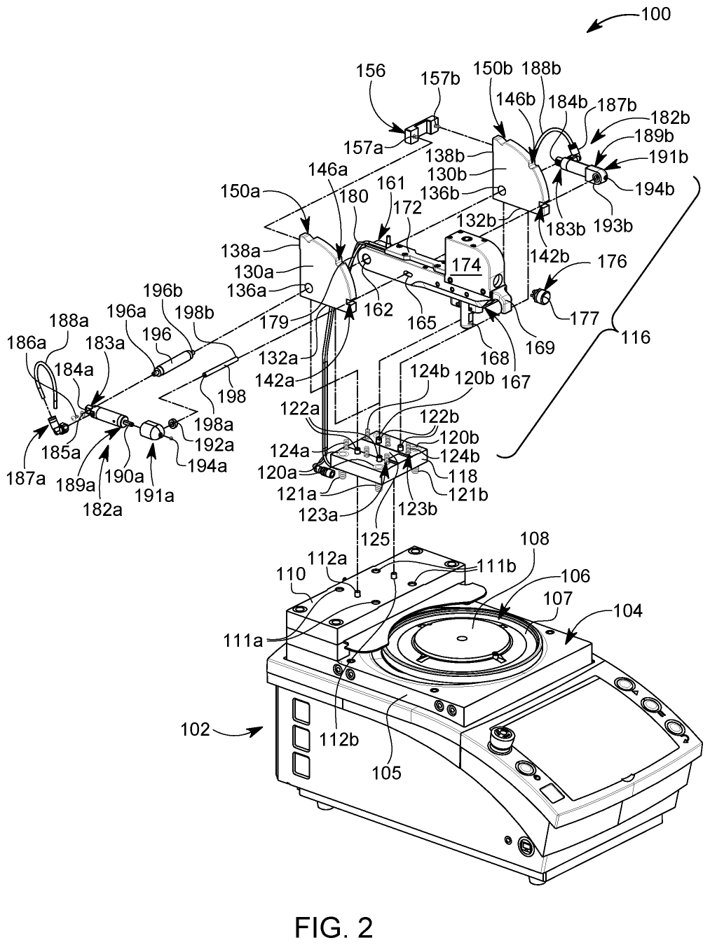

FIG. 3 is a perspective view of the optical fiber polisher shown in FIG. 2 with the overarm assembly in an engaging position and in an operating position.

FIG. 4A is a side view of the optical fiber polisher shown in FIG. 3 with the pneumatic cylinder assembly removed to show the lock shaft positioned in the overarm slot.

FIG. 4B is a magnified portion of the optical fiber polisher shown in FIG. 4A showing a lock shaft in the engaging position.

FIG. 5 is a perspective view of the optical fiber polisher shown in FIG. 2 with the overarm assembly in a releasing position and proximate the operating position.

FIG. 6A is a side view of the optical fiber polisher shown in FIG. 5 with the pneumatic cylinder assembly removed to show the lock shaft positioned in the overarm slot.

FIG. 6B is a magnified portion of the optical fiber polisher shown in FIG. 6A showing a lock shaft in the releasing position.

FIG. 7 is a perspective view of the optical fiber polisher shown in FIG. 2 with the overarm assembly in a releasing position and proximate a replacement position.

FIG. 8 is a perspective view of the optical fiber polisher shown in FIG. 2 with the overarm assembly in an engaging position and in a cleaning position.

FIG. 9 is a perspective view of another embodiment optical fiber polisher constructed in accordance with the principles of the present invention in a first position.

FIG. 10 is a perspective view of the optical fiber polisher shown in FIG. 9 in a second position.

FIG. 11 is a flow diagram illustrating a method for repositioning an overarm of the optical fiber polisher shown in FIG. 9.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide an optical fiber polishing arm assembly comprising a base, at least one side support, an overarm, and a lock shaft. The at least one side support is operatively connected to the base and has a first radial edge with at least one notch. The overarm is pivotally operatively connected to the base and includes a lock bore selectively aligned with the at least one notch. The lock shaft extends at least partially through the lock bore and is configured and arranged to selectively engage the at least one notch.

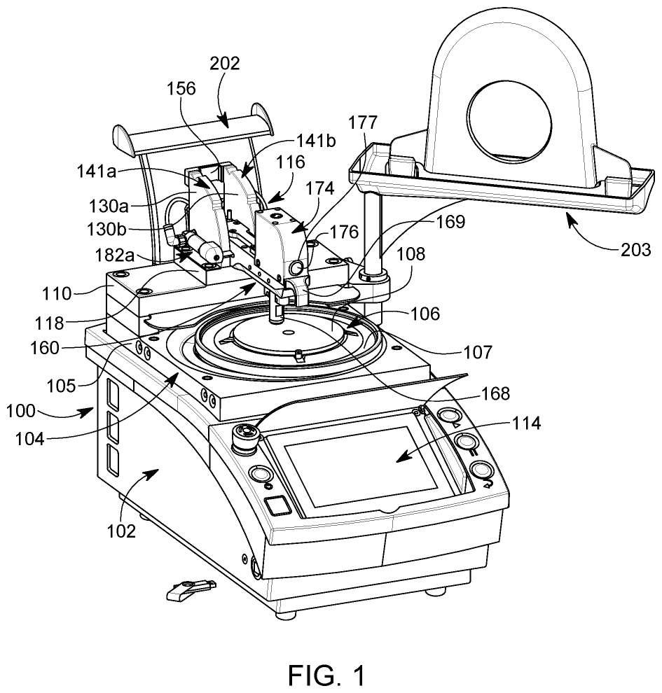

FIG. 1 illustrates a perspective view of an optical fiber polisher 100 according to one example. Optical fiber polisher 100 may be an Optical Fiber Polishing Machine APM Model HDC-5400 by Domaille Engineering, LLC of Rochester, Minnesota. Although optical fiber polisher 100 is generally shown and described, it is recognized that other suitable types of polishers could be used with the present disclosure.

Generally, the polisher 100 includes a housing 102 containing a processor (not shown) and an input device 114. The top of the housing 102 includes a base 105 supporting a polishing unit 104 and an overarm mounting base 110. The polishing unit 104 comprises a platen assembly 106 including a platen 107 rotatably supported by the base 105. The platen 107 is configured and arranged to support a polishing plate 108, which can be one of various types of substrates to which various types of polishing films would adhere. A polishing plate could be comprised of glass, ceramic, stainless steel or rubber. An overarm assembly 116, which is preferably a pneumatic overarm assembly, is operatively connected to the overarm mounting base 110. An optional cable management attachment 202 can be connected to the back of the housing 102 for supporting fiber optic cables undergoing a polishing process, and an optional drip tray and splash guard 203 can be connected to the housing 102.

In this example, an overarm mounting plate 118 is secured to the overarm mounting base 110. The overarm mounting base 110 includes upwardly extending pegs 112a and 112b configured and arranged to be received in peg receivers (not shown) in the bottom of the overarm mounting plate 118. The overarm mounting base 110 includes threaded bores 111a and 111b configured and arranged to receive fasteners 121a and 121b extending downwardly through bores 120a and 120b, respectively, in the overarm mounting plate 118. The overarm mounting plate 118 includes upwardly extending pegs 122a and 122b configured and arranged to be received in peg receivers (not shown) in the bottoms 132a and 132b of first and second side supports 130a and 130b. The bottoms 132a and 132b also include threaded bores (not shown) configured and arranged to receive fasteners 124a and 124b extending upwardly through bores 123a and 123b in the plate 118. The first side support 130a includes the bottom 132a, a rear 138a generally perpendicular to the bottom 132a, and a front, radial edge 141a interconnecting the rear 138a and the bottom 132a. The second side support 130b includes the bottom 132b, a rear 138b generally perpendicular to the bottom 132b, and a front, radial edge 141b interconnecting the rear 138b and the bottom 132b. Proximate the bottoms 132a and 132b and the rears 138a and 138b the first and second side supports 130a and 130b include pivot apertures 136a and 136b, respectively. The front, radial edges 141a and 141b include aligned notches. The first side support 130a includes a first notch 142a proximate the bottom 132a, a third notch 150a proximate the rear 138a, and a second notch 146a positioned between the first and third notches 142a and 150a. The second side support 130b includes a first notch 142b proximate the bottom 132b, a third notch 150b proximate the rear 138b, and a second notch 146b positioned between the first and third notches 142b and 150b. The first notches 142a and 142b are aligned, the second notches 146a and 146b are aligned, and the third notches 150a and 150b are aligned. The first notches 142a and 142b include top surfaces 143a and 143b that are generally parallel to bottom surfaces 144a and 144b thereby forming generally rectangular shaped openings. The second notches 146a and 146b include top surfaces 147a and 147b that are preferably angled toward the rears and bottom surfaces 148a and 148b that form stops. The third notches 150a and 150b include top surfaces 151a that are preferably angled more than the top surfaces 147a and 147b toward the rears and bottom surfaces 152a and 152b that form stops. Preferably, at least notches 146a, 146b, 150a, and 150b are not squared off but are rounded or tapered. The plate 118 includes an overarm support surface 125 positioned between the first and second side supports 130a and 130b. Preferably, a connector 156 interconnects the distal ends of the rears 138a and 138b secured thereto with fasteners 157a and 157b. As illustrated, it is preferred that two side supports are used but it is recognized that only one side support could be used.

The overarm assembly 116 includes an overarm 160 pivotally connected proximate one end to the base 105. Preferably, the overarm 160 includes a proximal end 161 through which a pivot bore 162 extends. A pivot shaft 196 is configured and arranged to extend through the first side support's pivot aperture 136a, through the overarm's pivot bore 162, and through the second side support's pivot aperture 136b. The pivot shaft 196 includes a first end 196a configured and arranged to extend through a bore 184a of a proximal end 183a of a first pneumatic cylinder 182a and a second end 196b configured and arranged to extend through a bore 184b of a proximal end 183b of a second pneumatic cylinder 182b. A washer 185a and a fastener 186a secure the first end 196a to the proximal end 183a, and the second end 196b is similarly secured to the proximal end 183b. Hose connectors 187a and 187b interconnect the cylinders 182a and 182b to hoses 188a and 188b, respectively, as is well known in the art. The distal ends 189a and 189b include piston rods (only 190a shown) extending outward therefrom. The piston rods are threaded and operatively connected to connectors 191a and 191b. They are locked in place with set screws 194a and 194b, respectively, to prevent movement while in operation. Although one pneumatic cylinder or other suitable actuation device could be used, preferably a pair of pneumatic cylinders 182a and 182b are coupled to opposing sides of the overarm 160, opposing rotational movement thereof. A mandrel 168 extends downward from a bottom surface proximate the distal end 167 of the overarm 160 and is configured and arranged, as is well known in the art, to connect to a mounting tube of a fixture. A positioning handle 169 is operatively connected proximate a front surface of the distal end 167. A load cell assembly 174 is operatively connected to a top surface proximate the distal end 167. An activation button 176 is operatively connected to the load cell housing and preferably includes an indicator 177, which is a light about the button's perimeter that provides a visual indication of the operation status. Air hose 179 and wire 180 are operatively connected to the load cell assembly 174 and extend along the top surface of the overarm 160 and outward from the proximal end 161. A top plate 172 is operatively connected to the top surface of the overarm 160 and is configured and arranged to contain and protect the air hose 179 and wire 180 along the top surface of the overarm 160. Protection of the air hose 179 and wire 180 reduces the risk of altering the pressure readings. Preferably, the top plate 172 also provide strain relief for the air hose 179 and wire 180. The air hose 179 sends air to the pneumatic cylinder to apply pressure to the polishing fixture. The wire 180 is connected to the load cell for pressure feedback to the control. Another wire (not shown) extends through the top plate 172 and is connected to the terminals on the back of the button 176. An intermediate portion 164 of the overarm 160 includes a lock bore 165. Preferably, the lock bore 165 is a slot and, also preferably, the slot is angled upward proximate its proximal end.

A lock shaft 198 is configured and arranged to extend through the overarm's lock bore 165 and its ends 198a and 198b are configured and arranged to fit within receivers (only 193b shown) of the connectors 191a and 191b. Optionally, bushings (only 192a shown) can be used to facilitate rotation of the lock shaft 198 within the receivers. Thus, the connectors 191a and 191b interconnect the lock shaft 198 and the pneumatic cylinders 182a and 182b, and the lock shaft 198 is able to rotate or roll relative to the connectors 191a and 191b. The connectors 191a and 191b are configured and arranged to keep debris out of the actuation assembly. The lock shaft 198 is also configured and arranged to selectively extend through the aligned notches in the first and second side supports 130a and 130b. The pneumatic cylinders 182a and 182b selectively move the lock shaft 198 between an engaging position 208 (within the notches) and a releasing position 209 (out of the notches).

Generally, the polisher 100 maintains rigid control of each polishing process through feedback mechanisms that control the operation of both the platen assembly 106 and the overarm assembly 116. The feedback mechanisms communicate with the processor to continuously monitor the performance of the platen assembly 106 and the overarm assembly 116 to ensure that both are functioning at their set levels. In some examples, the processor communicates with a porting device, the input device 114, and a USB port for a keyboard to enable rapid programming of the polisher 100. The input device 114 also serves as a visual indicator of actual operating parameters. The load cell detects pressure and is preferably connected to an air cylinder for pneumatically controlled consistent polishing pressure. According to one example, the processor causes the platen 107 to move, and causes overarm 160 to apply a downward force on a fixture holding one or more fiber optic connectors, which causes the end faces of the fiber optic connectors to be pressed into a polishing film resting on the platen 107. Optionally, the overarm assembly 116 includes a sensor, which allows for operation to start when the overarm 160 is in the proper position.

In operation, the overarm 160 pivots relative to the base 105 to provide for easy cleaning of fiber optic connectors in the fixtures between polishing steps and for the change of fixtures post processing. The overarm assembly 116 is repositionable by actuating the pneumatic cylinders 182a and 182b, which moves the lock shaft 198 from the engaging position 208 into the releasing position 209. This allows the overarm 160 to be pivoted relative to the base 105. Preferably, the lock shaft 198 is configured and arranged to rotate or roll so that as it moves in or out of the desired notches there is reduced friction and wear on the assembly. When the overarm 160 is positioned in the operating or polishing position 212, if the lock bore 165 is an angled slot, the movement of the lock shaft 198 within the lock bore 165 from the releasing position 209 into the engaging position 208 increases pressure the lock shaft 198 places on the overarm 160 thereby increasing the pressure of the overarm 160 against the mounting plate 118 and stabilizing its engaging position 208. Preferably, the lock bore 165 is angled less than 20 degrees, and more preferably approximately 10 degrees, relative to the longitudinal axis of the overarm 160. Alternatively, the lock bore 165 could be straight and the top surfaces 143a and 143b of the side support notches 142a and 142b could be angled to achieve the same result. Therefore, preferably, there is an angular difference between the lock bore and the top surfaces of the notches to create the downward force of the overarm. Preferably, the angular difference is less than 20 degrees, and more preferably approximately 10 degrees. The less angular difference, the tighter hold but more chance of sticking/binding and the locations of the notches may be more important because the lock shaft needs to engage before it runs out of travel. The more angular difference, the less hold but will allow for more tolerance of machined parts. Preferably, the button 176 is an electronic button, controlled by software, that acts as a lockout feature preventing actuation of the pneumatic cylinders 182a and 182b, and thereby the lock shaft 198, during polishing operations and/or when pressure is being applied. Pressing the button 176 actuates a compressed air valve, which releases the overarm locking mechanism. The pneumatic cylinders have internal springs that hold them in the locked position, and by pushing the button, air is applied to the air cylinders to overcome the spring pressure and release the clamp.

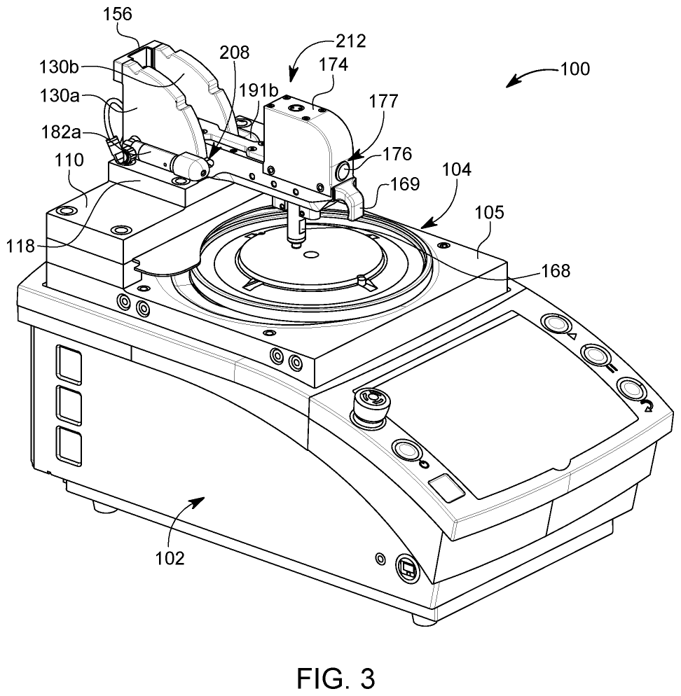

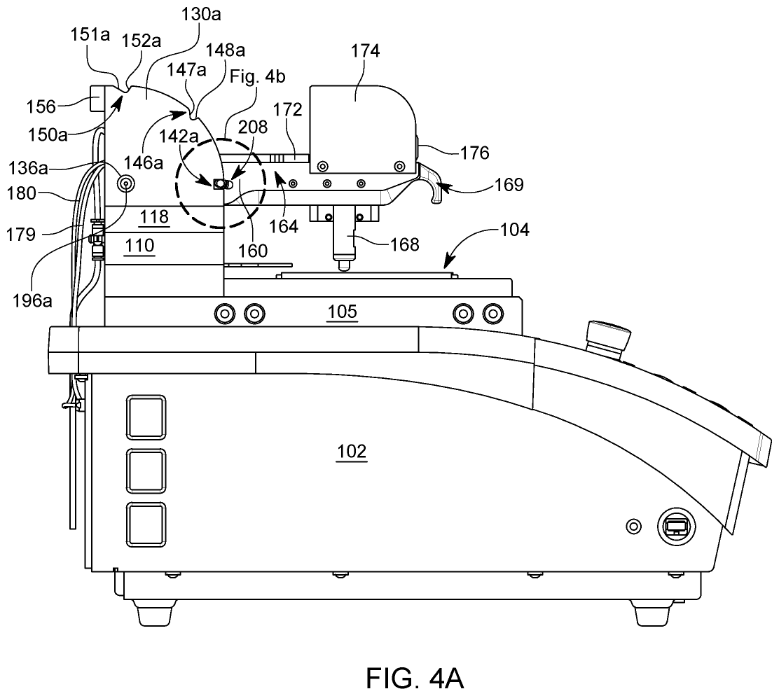

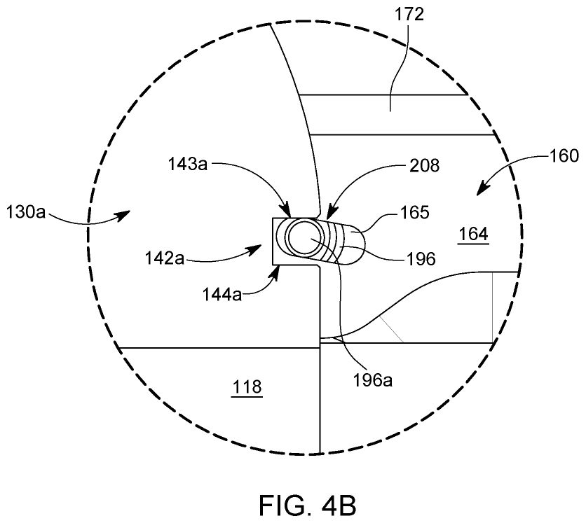

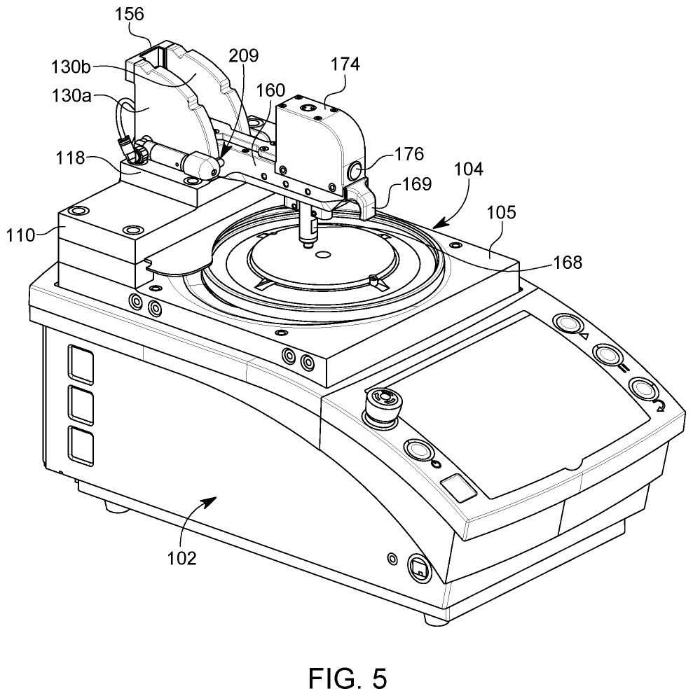

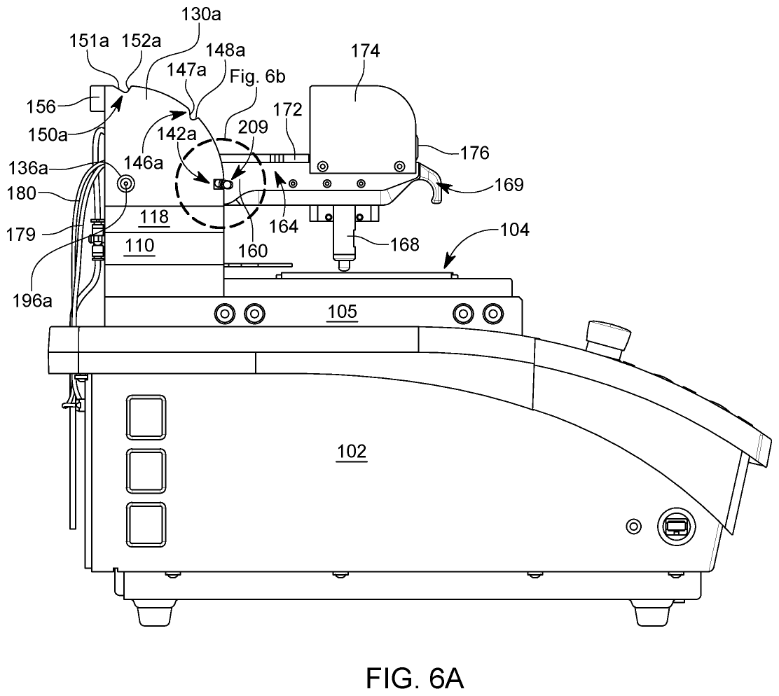

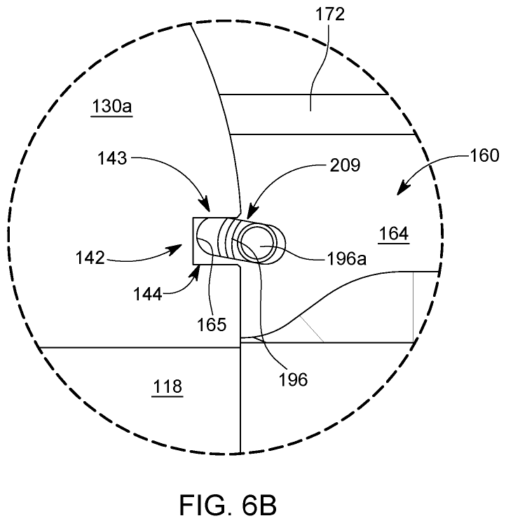

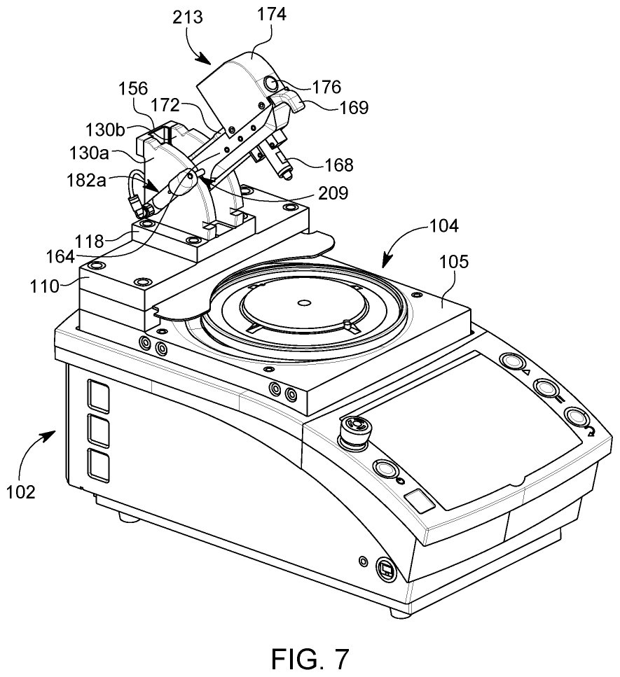

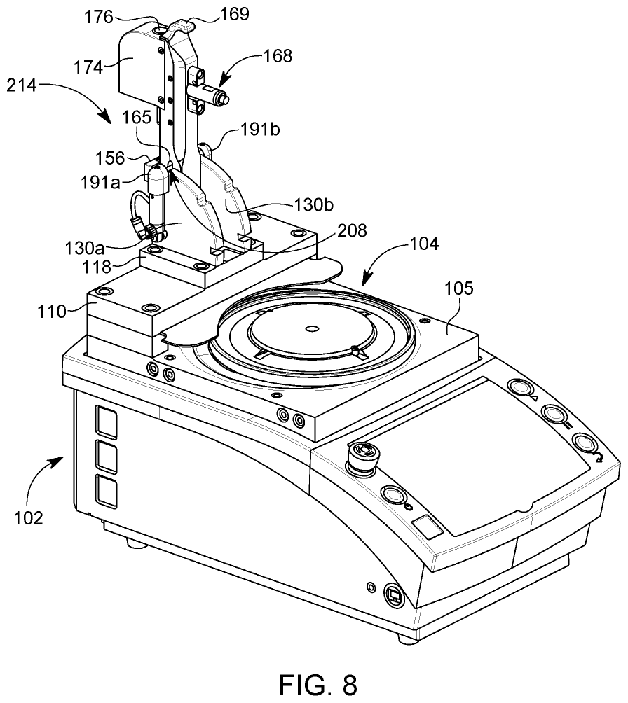

The notches 142a and 142b align to form an operating or polishing position 212. As shown in FIGS. 3, 4A, and 4B, the overarm assembly 116 is in the engaging position 208 with the lock shaft 198 positioned in the notches 142a and 142b (operating or polishing position 212). FIGS. 5, 6A, and 6B show the overarm assembly 116 in the releasing position 209 with the lock shaft 198 positioned out of the notches 142a and 142b relative to the operating or polishing position 212. The notches 146a and 146b align to form a releasing position 213. FIG. 7 shows the overarm assembly 116 in a releasing position 209 with the lock shaft 198 positioned out of the notches 146a and 146b relative to the releasing position 213. The notches 150a and 150b align to form a cleaning position 214. FIG. 8 shows the overarm assembly 116 in an engaging position 208 with the lock shaft 198 positioned in the notches 150a and 150b (cleaning position 214.) Preferably, at least notches 146a, 146b, 150a, and 150b are not squared off but are rounded or tapered to reduce wear on the lock shaft 198. Preferably, the bottom surfaces 148a, 148b and 152a, 152b angles are less than 40° to prevent the lock shaft 198 Shaft from accidental disengagement. Preferably, the top surfaces 147a, 147b and 151a, 151b angles are more than 50° to prevent the optical cables from getting pinched in the slot when the overarm is rotating past the notches. The radius between the angled surfaces of the notches are preferably smaller than the radius of the lock shaft 198 to allow the lock shaft 198 to locate on the angled surfaces to securely hold the overarm. The lock shaft preferably contacts the bottom surfaces 152a, 152b and forces the overarm back against the connector 156 to securely hold the overarm in the cleaning position.

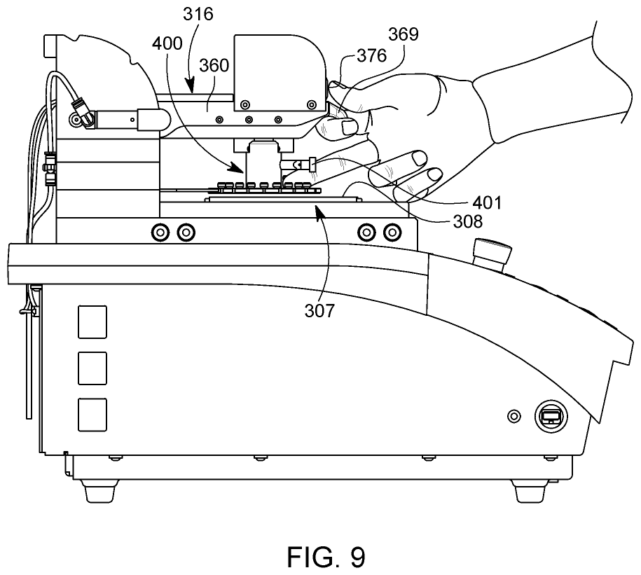

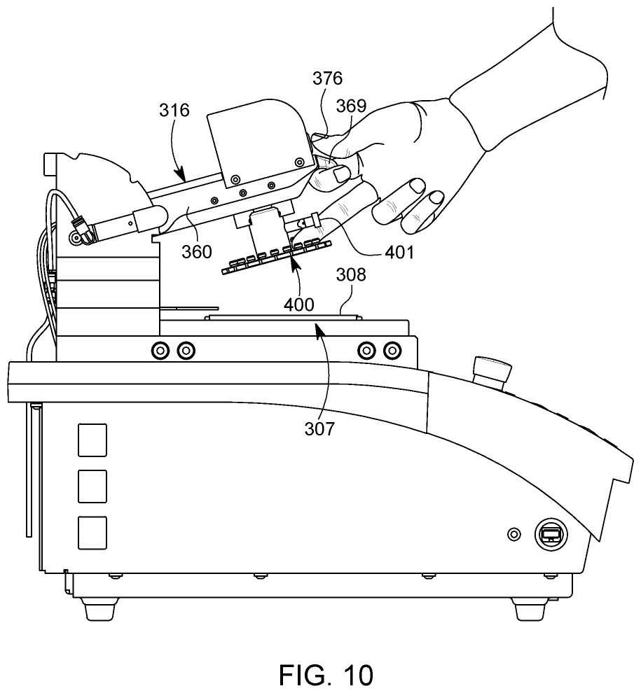

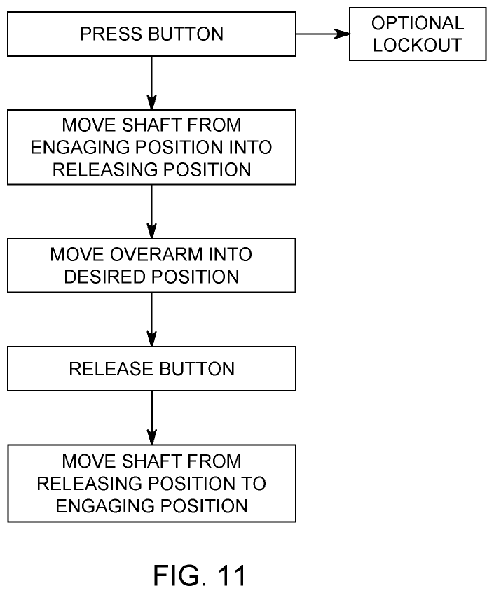

Another embodiment overarm assembly 316 is illustrated in FIGS. 9 and 10, and an example method of repositioning the overarm assembly 316 is illustrated in FIG. 11 and demonstrated in FIGS. 9 and 10. To reposition the overarm assembly 316, a user presses the button 376 with the user's thumb while positioning the handle 369 between the user's thumb and index finger. The handle 369 is engaged by the user's index finger and preferably by both the user's thumb and index finger. If a fixture 400 is operatively connected to the mandrel of the overarm 360, the user's middle finger can be positioned under the fixture's knob 401. With the user's hand positioned in this manner, the overarm 360 and the fixture 400, if connected to the overarm 360, can be easily lifted or lowered into the desired position when the overarm assembly 316 is in the releasing position. If the button 376 is released, the lock shaft 198 will roll along the radial edges of the side supports until the overarm is moved into one of the three positions and will engage the associated slots. When the overarm 360 is in the operating position and locked, and the platen 307 starts moving, the fixture 400 is slowly lowered so the optical fiber (not shown) gently touches the polishing film 308.

Benefits include improved reliability (e.g., reduced wear on the rolling lock shaft received in slots versus tapered pins received in apertures), improved safety and control (e.g., the user cannot release the arm while polishing pressure is applied due to electrical lockout, for example of the button), improved ergonomics (e.g., the handle/finger hook is configured and arranged to facilitate multi-finger lifting of the fixture), improved automation (e.g., electronically actuated air valve locks the arm versus manual actuation)-then move arm to desired position.

The rolling lock shaft wears less than prior art pins, which are tapered for close fit but the friction when inserting/removing the pins wears on the pins and the supports. In addition, the prior art pins require a lot of machining to get the tapered ends. The pins can be replaced once and then the next time the overarm assembly must be replaced because there is too much wear on the assembly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An optical fiber polishing arm assembly, comprising:
a base;
a first side support operatively connected to the base and having a first radial edge with at least a first notch;
an overarm pivotally operatively connected to the base and including a lock bore selectively aligned with the first notch; and
a lock shaft extending at least partially through the lock bore and configured and arranged to selectively engage the first notch.

2. The assembly of claim 1, wherein the lock shaft is cylindrical and is configured and arranged to roll relative to the overarm and the first side support.

3. The assembly of claim 1, further comprising:
a second side support operatively connected to the base and having a second radial edge with at least a second notch, the first and second side supports forming a channel, the first and second notches being aligned;
wherein the overarm is positioned within the channel; and
wherein the lock shaft extends through the lock bore and is configured and arranged to selectively engage the first and second notches.

4. The assembly of claim 3, wherein the first and second side supports include first and second side support bores, respectively, and the overarm includes a pivot bore aligned with the first and second side support bores, wherein the first and second side support bores and the overarm bore are configured and arranged to receive a pivot shaft for pivotal connection of the overarm to the first and second side supports.

5. The assembly of claim 3, further comprising:
the first side support including a third notch and a fifth notch;
the second side support including a fourth notch and a sixth notch, the fourth notch being aligned with the third notch, the sixth notch being aligned with the fifth notch; and
wherein the first and second notches form an operating position, the third and fourth notches form a releasing position, and the fifth and sixth positions form a cleaning position.

6. The assembly of claim 1, wherein the lock bore is a slot and the lock shaft is configured and arranged to move within the slot to selectively engage the first notch.

7. The assembly of claim 5, wherein the slot and the first notch have an angular difference of less than 20 degrees to increase a downward pressure of the lock shaft on the overarm when positioned within the first notch.

8. The assembly of claim 1, further comprising a first pneumatic cylinder operatively connected to the lock shaft and configured and arranged to selectively move the lock shaft relative to the first side support.

9. The assembly of claim 1, further comprising an actuation button configured and arranged to selectively move the lock shaft relative to the first side support, the actuation button including a status indicator.

10. The assembly of claim 9, further comprising a lockout feature controlled by software configured and arranged to prevent movement of the lock shaft during operation.

11. The assembly of claim 1, wherein the overarm includes a lifting handle proximate its distal end configured and arranged to receive a user's finger.

12. An optical fiber polishing arm assembly, comprising:
a base;
a first side support and a second side support operatively connected to the base and forming a channel therebetween, the first side support having a first radial edge with at least a first notch, the second side support having a second radial edge with at least a second notch, the first and second notches being aligned;
an overarm pivotally operatively connected to the base within the channel, the overarm including a lock bore selectively aligned with the first and second notches; and
a lock shaft extending through the lock bore and configured and arranged to selectively engage the first and second notches.

13. The assembly of claim 12, wherein the lock shaft is cylindrical and is configured and arranged to roll relative to the overarm and the first and second side supports.

14. The assembly of claim 12, wherein the first and second side supports include first and second side support bores, respectively, and the overarm includes a pivot bore aligned with the first and second side support bores, wherein the first and second side support bores and the overarm bore are configured and arranged to receive a pivot shaft for pivotal connection of the overarm to the first and second side supports.

15. The assembly of claim 12, wherein the lock bore is a slot and the lock shaft is configured and arranged to move within the slot to selectively engage the first and second notches.

16. The assembly of claim 15, wherein the slot and the first and second notches have an angular difference of less than 20 degrees to increase a downward pressure of the lock shaft on the overarm when positioned within the first and second notches.

17. The assembly of claim 12, further comprising first and second pneumatic cylinders operatively connected to first and second ends, respectfully, of the lock shaft and configured and arranged to selectively move the lock shaft relative to the first and second side supports.

18. The assembly of claim 12, further comprising:
the first side support including a third notch and a fifth notch;
the second side support including a fourth notch and a sixth notch, the fourth notch being aligned with the third notch, the sixth notch being aligned with the fifth notch; and
wherein the first and second notches form an operating position, the third and fourth notches form a releasing position, and the fifth and sixth positions form a cleaning position.

19. The assembly of claim 12, further comprising an actuation button configured and arranged to selectively move the lock shaft relative to the first and second side supports, the actuation button including a status indicator.

20. The assembly of claim 12, wherein the overarm includes a lifting handle proximate its distal end configured and arranged to receive a user's finger.

21. A method of repositioning an optical fiber polishing arm assembly, comprising:
pressing a button thereby actuating a pneumatic cylinder to move a lock shaft from a first engaging position into a releasing position by moving the lock shaft out of a first pair of notches, an overarm being positioned between the first pair of notches and the lock shaft extending through a lock bore in the overarm, wherein there is an angular difference between the first pair of notches and the lock bore;
positioning the overarm in a desired position;
releasing the button thereby moving the lock shaft into a second engaging position by moving the lock shaft into a second pair of notches, wherein as the lock shaft moves within the lock bore downward pressure increases on the overarm due to the angular difference.

22. The method of claim 21, wherein the button is pressed by a user's thumb and wherein the overarm is positioned into the desired position by positioning a user's index finger under a positioning handle to raise or lower the overarm.

23. The method of claim 22, further comprising positioning a fixture operatively connected to the overarm along with the overarm by positioning a user's middle finger under a knob of the fixture.

24. The method of claim 21, further comprising locking out actuation of the pneumatic cylinder during operation.
